(19) United States
(12) Patent Application Publication
(10) Pub. No.: US 2007/0092268 A1
(43) Pub. Date: Apr. 26, 2007

(54) Image forming device, control method thereof, and computer readable medium recording a control program

(76) Inventor: Shigeyuki Takahashi, Nagano-ken (JP)

Correspondence Address: STROOCK & STROOCK & LAVAN LLP, 180 MAIDEN LANE, NEW YORK, NY, 10038, US

(21) Appl. No.: 11/257,265

(22) Filed: Oct. 24, 2005

(51) Int. Cl. G03G 15/00

(52) U.S. Cl. 399/12

(57) ABSTRACT

It is an object of the present invention to provide an image forming device to which a cartridge containing image forming material is removably installed, and with which, if a non-guaranteed cartridge is installed which is not the object of a product quality guarantee by the maker, the task of exchanging this cartridge can be performed simply and accurately. The image forming device to which a cartridge containing image forming material is removably installed, and which performs image forming using the image forming material contained in the cartridge, includes a detection portion that detects whether or not the cartridge which is installed is a non-guaranteed cartridge which is not the object of a product quality guarantee, and a shift portion that, when the detection portion detects that the cartridge which is installed is a non-guaranteed cartridge, shifts the non-guaranteed cartridge to a position in which a cartridge can be exchanged.

### BACKGROUND OF THE INVENTION

1. Field of the Invention

The present invention relates to an image forming device or the like in which a cartridge containing material for image forming is removably installed, and more particularly relates to an image forming device or the like with which the operation of exchanging cartridges can be performed in a simple and accurate manner when a cartridge of which the product quality is not guaranteed by the maker is installed.

2. Description of the Related Art

Generally, with an image forming device such as a printer, a facsimile, a photocopier or the like which creates images using an electronic photographic technique, image forming is performed by creating an electrostatic latent image according to image data, supplying a toner which is a developer (i.e., image forming material) to this electrostatic latent image so as to develop a toner image, and transferring this toner image to the medium which is to be the object of transfer. With this type of device, the toner cartridge which contains the above described toner is made so as to be installed in a removable manner; and, normally, a toner cartridge containing black toner is installed to a device which performs image forming in monochrome, while toner cartridges containing toners of a plurality of colors (for example four color toner cartridges containing yellow Y, magenta M, cyan C, and black K) are installed to a device which performs image forming in color. And, when the toner in a toner cartridge which is installed runs out, it is exchanged for a new toner cartridge which is filled with toner.

Furthermore, among these toner cartridges, there are some cartridges which are the object of a product quality guarantee by the maker of the image forming device (hereinafter these will be termed “guaranteed cartridges”), and there are some which are not the object of such a product quality guarantee (hereinafter these will be termed “non-guaranteed cartridges”); and, if a non-guaranteed cartridge is installed, it may happen that the image forming device cannot exhibit a sufficiently high performance. In this connection, with the objective of stopping a user who does not know that the cartridge which is installed is a non-guaranteed cartridge from performing printing using this non-guaranteed cartridge, which would not be desirable, a technique for detecting whether or not the cartridge which is installed is a non-guaranteed cartridge has been proposed (for example, in Japanese Patent Laid-Open Publication 2004-199095 and the like).

And, with prior art devices, since it is desirable that a guaranteed cartridge should be installed when it is detected that a non-guaranteed cartridge is installed, accordingly this is treated as an error, and this error is displayed to the user.

However, with the prior art devices, when displaying an error due to the fact that the above described non-guaranteed cartridge is installed, when the user exchanges the cartridge, it is necessary for him first to cancel the error which is displayed by using an operation button or the like provided to the image forming device, and thereafter to perform the task of selecting a toner exchange command upon the operation menu and to exchange the cartridge. The task of performing a plurality of procedures in this manner is irksome from the point of view of the user; and furthermore since, if a plurality of non-guaranteed cartridges are installed, an error only indicating the installation of non-guaranteed cartridges is displayed, and the cartridges which need to be exchanged by the user must be exchanged successively without any mistake, this constitutes a further irksome task, and moreover there is also a possibility of a mistake occurring during this exchange task.

Furthermore, if the image forming device is of a kind which counts the number of error cancellations with regard to this type of error described above which is due to a non-guaranteed cartridge, since it is necessary to perform the error cancellation as described above even though the task of exchanging this non-guaranteed cartridge for a guaranteed cartridge is performed, accordingly the error cancellation count comes to increase, which is not desirable. This cancellation error count is stored within the image forming device, and is referred to when the state of affairs comes about that the device cannot provide its proper performance, or the like; and, from the point of view of the user, it is not desirable for its value to increase. Accordingly, although there is no way of avoiding this number of error cancellations increasing if errors due to non-guaranteed cartridges are repeatedly cancelled and attempts are repeatedly made to use non-guaranteed cartridges, nevertheless, as described above, when such a non-guaranteed cartridge is exchanged for a guaranteed cartridge, in this case, it is not desirable that the number of error cancellations should increase.

### SUMMARY OF THE INVENTION

Thus, an object of the present invention is to provide an image forming device or the like to which a cartridge containing image forming material is removably installed, and with which, if a non-guaranteed cartridge which is not the object of a product quality guarantee by the maker is installed, the task of exchanging this cartridge is made simple and easy and also accurate.

In order to achieve the above described object, according to its one aspect, the present invention proposes an image forming device to which a cartridge containing image forming material is removably installed, and which performs image forming using the image forming material contained in the cartridge, comprising: a detection portion that detects whether or not the cartridge which is installed is a non-guaranteed cartridge which is not the object of a product quality guarantee; and a shift portion that, when the detection portion detects that the cartridge which is installed is a non-guaranteed cartridge, shifts the non-guaranteed cartridge to a position in which a cartridge can be exchanged.

Furthermore, according to a desirable specialization of the present invention, there may be further included a display portion that, after the shift portion has shifted the non-guaranteed cartridge to the position in which a cartridge can be exchanged, performs a display which informs a user that an error related to the non-guaranteed cartridge has occurred; and wherein, when exchange of the cartridge which has been shifted to the position in which a cartridge can be exchanged is performed by the user in response to the display, the error is cancelled without any error cancellation operation by the user.

Moreover, according to another desirable specialization of the present invention, if the detection portion detects that a plurality of cartridges which are installed are non-guaranteed cartridges, display by the display portion and shifting by the shift portion may be performed for each one of the plurality of non-guaranteed cartridges in a predetermined order.

And, in order to achieve the above described object, according to another aspect thereof, the present invention proposes a control method for an image forming device to which a cartridge containing image forming material is removably installed, and which performs image forming using the image forming material contained in the cartridge, the method including: a detection step of detecting whether or not the cartridge which is installed is a non-guaranteed cartridge which is not the object of a product quality guarantee; and a shift step of, when it is detected in the detection step that the cartridge which is installed is a non-guaranteed cartridge, shifting the non-guaranteed cartridge to a position in which a cartridge can be exchanged.

And, in order to achieve the above described object, according to yet another aspect thereof, the present invention proposes a computer readable medium recording a control program for an image forming device to which a cartridge containing image forming material is removably installed, and which performs image forming using the image forming material contained in the cartridge, the control program causing the image forming device to execute: a detection step of detecting whether or not the cartridge which is installed is a non-guaranteed cartridge which is not the object of a product quality guarantee; and a shift step of, when it is detected in the detection step that the cartridge which is installed is a non-guaranteed cartridge, shifting the non-guaranteed cartridge to a position in which a cartridge can be exchanged.

Yet further objectives and features of the present invention will become apparent from the preferred embodiment of the present invention explained hereinafter.

### BRIEF DESCRIPTION OF THE DRAWINGS

FIG. 1 is a block diagram of an embodiment of an image forming device to which the present invention has been applied;

FIG. 2 is a schematic sectional view mainly showing, a portion of the mechanism of an engine 6 of this printer 2;

FIG. 3 is a flow chart showing an example of a non-guaranteed product error procedure performed by the CPU 42; and

FIG. 4 is a figure showing an example of a message relating to a non-guaranteed product error which is displayed.

### DESCRIPTION OF THE PREFERRED EMBODIMENTS

In the following, a preferred embodiment of the present invention will be explained with reference to the figures. However, this embodiment is not to be considered as being limitative of the technical range of the present invention. Moreover it should be understood that, in the figures and in the following explanation, to elements which are the same or similar, the same reference numbers or symbols are appended.

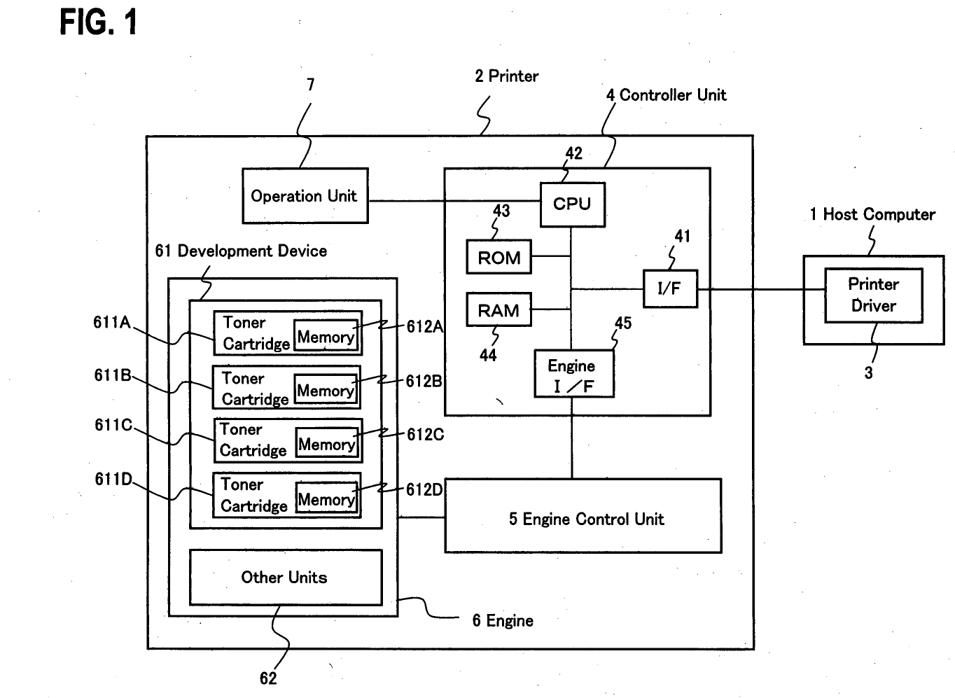

FIG. 1 is a block diagram of an embodiment of a printer, which is an image forming device to which the present invention has been applied. The printer 2 shown in FIG. 1 is an image forming device to which the present invention has been applied, and it is a device which performs image forming on a predetermined printing medium (paper) based on a printing request from a host computer 1, or the like. This printer 2 is one which is built so that, when it has detected that a non-guaranteed cartridge has been installed as the toner cartridge 611, it automatically shifts the toner cartridge 611 to an exchange position, so that the task of exchanging such a non-guaranteed cartridge may be performed simply and accurately.

The host computer 1 shown in FIG. 1 is a host device which issues a printing request to the printer 2, and it transmits printing data including image data and control commands to the printed 2, based on operation by the user or the like. It should be understood that this host computer 1 may consist of a so-called personal computer or the like. A printer driver 3 within the host computer 1 receives data from an application within the host computer (not shown in the figures) or the like, and generates the above described printing data and transmits it to the printer 2. It should be understood that this printer driver 3 is a program which is executed for causing the host computer 1 to perform processing related to the above described function, so that the above described function is attained by a control device (not shown in the figures) of the host computer 1 performing procedures according to the program.

As shown in FIG. 1, the printer 2 comprises a controller unit 4, an engine control unit 5, an engine 6, an operation unit 7, and the like; it may be, for example, a so-called four-cycle laser printer.

The controller unit 4 receives the printing data which is transferred from the host computer 1, and, along with interpreting the control commands included in the data, also performs predetermined processing on the image data included in the data and generates data for supply to the side of the engine 6. As shown in FIG. 1, this controller unit 4 comprises an I/F 41, a CPU 42, a ROM 43, a RAM 44, and an engine I/F 45.

The I/F 41 is a section which receives the printing data which is transmitted from the host computer 1, while the ROM 43 is a section which stores various programs for controlling this printer 2. And the RAM 44 is a memory which stores the printing data which has been received, and the image data for each page on which the procedure of printing is to be performed by the engine 6 is transferred from here to the engine I/F 45.

The CPU 42 is a section which controls various types of procedure executed by this printer 2, and, in particular, it is in charge of the procedure of storing the image data included in the printing data which has been received in the RAM 44, the procedure of interpreting the control commands included in the printing data and commanding the engine control unit 5 to perform appropriate printing procedures, the procedure of controlling the operation unit 7 to provide an interface with the user, and the like. This printer 2 is particularly distinguished by the characteristic that, if the toner cartridge 611 which is installed is a non-guaranteed cartridge, then an error procedure and so on is performed by the CPU 42; and the concrete details thereof will be described hereinafter. It should be understood that, principally, the procedures and so on which are executed by the CPU 42 are performed according to programs stored in the ROM 43.

Next, the engine I/F 45 is a section which, during the operation of printing by the engine 6, reads out pixel data stored in the previously described RAM 44 at a predetermined timing, and transfers this data to the side of the engine 6 after having performed predetermined procedures thereon; and it is also in charge of the interface between the controller unit 4 and the engine 6. It should be understood that a memory which stores data temporarily, a decompressing unit, a screen processing unit, and the like are comprised within this engine I/F 45, although these elements are not shown in the figures; and these perform decompression of compressed data in the picture element data which has been read out from the RAM 44, while also performing screen processing for converting it to dot data and the like. Moreover, in concrete terms, this engine I/F 45 may be embodied as an ASIC.

Next, the engine control unit 5 comprises a CPU, a 10. ROM, a RAM, and the like, although these elements are not shown in the figures; and it controls the operation of the various portions of the engine 6, as will be explained hereinafter. It should be understood that, when exchanging the toner cartridge 611, control is performed according to commands from the controller unit 4, in order to shift the toner cartridge 611 which is to be exchanged to the predetermined exchange position.

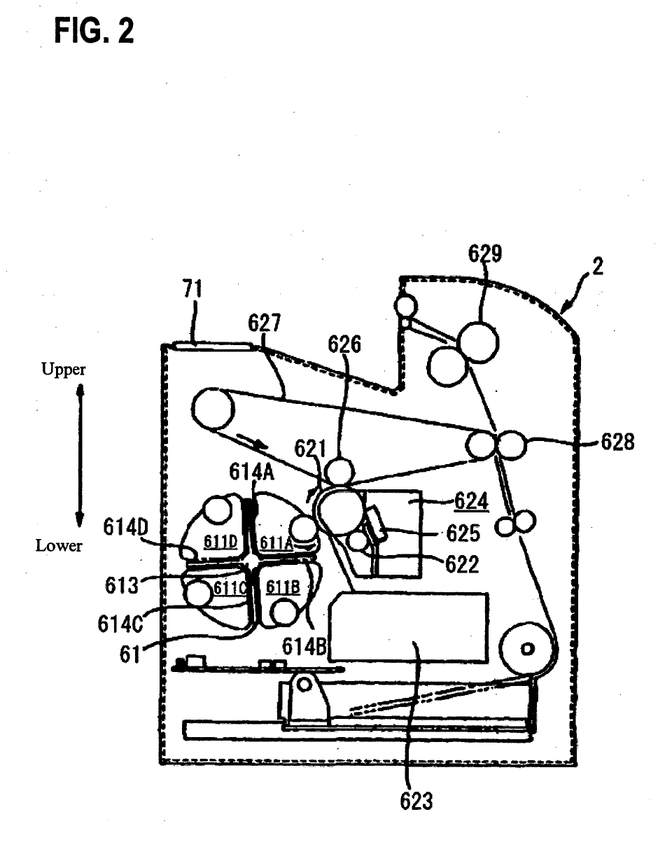

Next, although the engine 6 comprises an electrification unit, an exposure unit, a development device, a transfer unit, and the like, in FIG. 1, it is represented as being divided into the development device 61 and other units 62. FIG. 2 is a schematic sectional view focusing on the mechanism of the engine 6 of this printer 2. A photosensitive drum 621 comprises an electrically conductive main member shaped as a circular cylinder and a photosensitive layer formed on the outer peripheral surface of this main member, and is mounted so as to be capable of rotating around its central axis in the clockwise direction, as shown by the arrow sign in the figure. An electrification unit 622 electrifies this photosensitive drum 621, and an exposure unit 623 forms a latent image with static electricity by irradiating a beam from a light source such as an internally housed laser or LED array or the like upon the photosensitive drum 621 which has been thus electrified. This beam irradiation by the exposure unit 623 is controlled by a drive signal modulated based on the image information which is inputted from the host computer 1.

The development device 61 comprises installation units 614A through 614D in which toner cartridges 611A through 611D containing toner, which is a development material, are installed in a removable manner, and is a rotary development device which can rotate about its central axis 613. The development device 61 is rotated so that the one of the toner cartridges 611A through 611D which is required to be used is brought to be positioned next to the photosensitive drum 621, and, by the development material in that toner cartridge 611 being supplied onto the photosensitive drum 621 on which a latent image has been formed, that latent image is developed with the development material into an image.

It should be understood that, for example, toner cartridges 611A through 611D containing development material (toner) of the colors Y, M, C, and K respectively may be installed in the installation units 614A through 614D of the development device 61. Moreover, it should be understood that the letters A through D which are appended to the toner cartridges 611A through 611D and so on, are symbols for identifying the installation positions for these toner cartridges 611 in the development device 61.

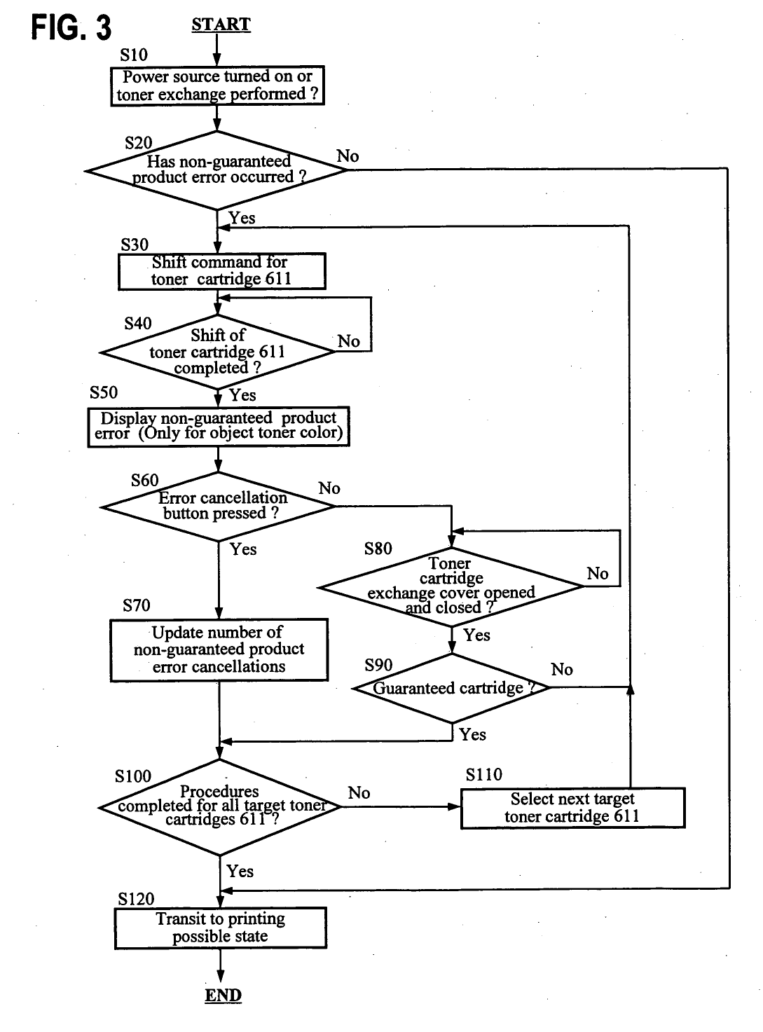

Furthermore although, as explained above, during printing or when exchanging a toner cartridge 611, the development device 61 rotates and causes a predetermined one of the toner cartridges 611 to shift to the predetermined position, a default position (a home position) is determined for each of the toner cartridges 611A through 611D, and when a predetermined procedure has been completed, it is returned to this home position in order to await the next procedure. Furthermore, an opening section (not shown in the figures) is provided in the body of the printer 2 in correspondence to the exchange position for exchanging the toner cartridges 611, and, moreover, a cover (also not shown in the figures) is provided so as to open and close this opening section. The home positions for the cartridges and the exchange position for exchanging the cartridges are the same as those shown in FIG. 3 of Japanese Patent Laid-Open Publication 2003-50495, the contents of which are hereby incorporated into the present application. The open or closed state of this cover can be detected by a limit switch or the like which is provided in the neighborhood of the cover, and the CPU 42 is able to decide as to whether or not the exchange of the toner cartridge 611 has been performed, according to whether the opening and closing of the cover has been performed, or the like.

Furthermore, memories 612A through 612D are provided to the toner cartridges 611A through 611D respectively, and, in each of these, there is stored cartridge information such as the manufacturing lot number, the history of use, and the amount of toner remaining, for the respective toner cartridges 611. This information stored in these memories 612 is read out, according to requirements, by the engine control unit 5 and/or the controller unit 4, and is used, in relation to each of the toner cartridges 611, for consumption product management, product quality guarantee product management and the like. This cartridge information which is stored in these memories 612 is also utilized for decision processing as to whether or not the toner cartridges 611 which are installed are non-guaranteed cartridges.

A primary transfer unit 626 transfers the toner image formed on the photosensitive drum 621 to an intermediate transfer member 627. This intermediate transfer member 627 may be, for example, an endless belt comprising a PET film with an aluminum layer formed on its surface by vapor deposition, and with a semi conductive coating formed on its surface, and it is rotationally driven at the same peripheral speed as the photosensitive drum 621. And a secondary transfer unit 628 transfers the toner image which has been formed on the intermediate transfer member 627 to a printing medium such as paper or the like, while a fixing unit 629 fixes the toner image which has been thus transferred to the printing medium onto the medium and makes it into a permanent image, with this printing medium then being ejected to the exterior of the printer 2.

A cleaning unit 624 is provided between the primary transfer unit 626 and the electrification unit 622, and comprises a cleaning blade 625 which contacts against the surface of the photosensitive drum 621, so that, after the primary transfer, the development material (toner) which remains on the photosensitive drum 621 is removed by this cleaning blade 625.

The operation unit 7 shown in FIG. 1 is a section for the user to operate the printer 2, and it comprises a display panel 71 (refer to FIG. 2) and operation buttons (an error cancellation button and so on) and the like. Various setting actions can be performed with this operation unit 7, such as setting of printing conditions for the printer 2 and the like. With regard to the processing related to non-guaranteed product errors which is a characteristic of this printer 2, display of non-guaranteed product errors and operation for cancellation of such errors are also performed via this operation unit 7.

With the printer 2 according to this embodiment which has a structure like the one explained above, during printing, the printing data which has been written in a predetermined language is supplied from the host computer 1, an electrostatic latent image is formed on the photosensitive drum 621, this image is developed with the corresponding toner cartridge 611, and transfer of the toner image to the intermediate transfer member 627 is performed by the primary transfer unit 626. And, furthermore, this image is transferred by the secondary transfer unit 628 to the printing medium such as paper or the like and is fixed by the fixing unit 629, the printing medium with the final image thereon then being ejected to the exterior of the printer 2.

Although the printer 2 mainly operates in this manner, with this printer 2, as previously mentioned, its distinguishing feature is the procedures which are executed when it has been detected that a non-guaranteed cartridge is installed, in other words its procedures related to a non-guaranteed product error; in the following, these matters will be explained in concrete terms.

FIG. 3 is a flow chart showing an example of the flow of control performed by the CPU 42 during the non-guaranteed product error procedure. This non-guaranteed product error procedure is performed when the power source to this printer 2 is turned on, and also when toner exchange has been performed and the like (the step S10 of FIG. 3). First, a decision is made (in a step S20 of FIG. 3) as to whether or not a non-guaranteed product error has occurred. This decision is performed by deciding whether or not a non-guaranteed cartridge is installed; if even one non-guaranteed cartridge is installed, it is considered that a non-guaranteed product error is occurring. Furthermore, this decision as to whether a non-guaranteed cartridge is installed is performed by the CPU 42 reading out the cartridge information which is stored in the memory 612 of each of the toner cartridges 611, and based on this cartridge information.

In concrete terms, for example, the decision as to whether each cartridge is a non-guaranteed cartridge or not may be performed based on the manufacturing lot or upon the history of use or the like which is included in the cartridge information, or by checking from the toner remaining amount information which is included in the cartridge information as to whether or not this is a refilled product (a cartridge in which the toner has merely been replenished). It should be understood that other methods may also be used for performing this decision.

If in this decision it has been determined that the toner cartridge 611 which is installed is not a non-guaranteed cartridge, so that no non-guaranteed product error has occurred (NO in the step S20 of FIG. 3), then this non-guaranteed product error procedure terminates, and the system transits to the printing possible state (in a step S120 of FIG. 3).

On the other hand, if in this decision it has been determined that the toner cartridge 611 which is installed is in fact a non-guaranteed cartridge, so that a non-guaranteed product error has occurred (YES in the step S20 of FIG. 3), then the CPU 42 issues a command (in a step S30 of FIG. 3) to the engine control unit 5 to shift this non-guaranteed cartridge to the cartridge exchange position. Here, if a plurality of such non-guaranteed cartridges are installed, then one among those cartridges is selected according to an order based on a predetermined method which has been determined in advance, and a command is issued to shift this selected non-guaranteed cartridge to the cartridge exchange position. This order based on the predetermined method may be, for example, to utilize the most efficient order for shifting all of the plurality of non-guaranteed cartridges to the exchange position.

Thereafter, the system waits (NO in a step S40 of FIG. 3) for the toner cartridge 611 which has been selected to be shifted to the exchange position according to the above shift command, and, when this shifting has been completed (YES in the step S40 of FIG. 3), the CPU 42 displays a non-guaranteed product error on the display panel 71 of the operation unit 7 (in a step S50 of FIG. 3).

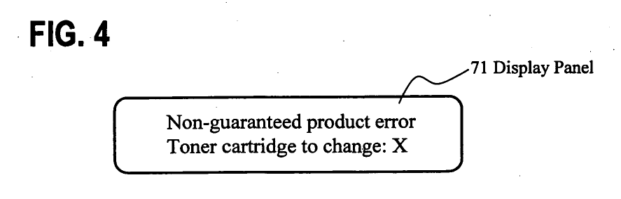

FIG. 4 is a figure showing an example of a message relating to a non-guaranteed product error which is displayed on the display panel 71. In the example shown in FIG. 4, in the upper line of the message, the user is informed that a non-guaranteed product error has occurred, while, in its lower line, the user is instructed to exchange that toner cartridge 611 which is identified as “X”. Here, “X” is information which identifies the toner cartridge 611 which has been selected and which has been shifted to the exchange position; for example, if one toner cartridge 611 of each color Y, M, C, and K is installed, then if, for example, “M” is displayed, the user is being instructed to exchange the M (magenta) colored toner cartridge 611. In other words, the user is informed by this message that the M colored toner cartridge 611 is a non-guaranteed cartridge, and he is being invited to exchange it for a guaranteed cartridge.

In this manner, with this printer 2, when a non-guaranteed product error is displayed, even if a plurality of non-guaranteed cartridges 611 are installed, display is performed only for that one of these toner cartridges 611 which has been shifted to the exchange position (to instruct the user to exchange it). And, before this error display, the cartridge 611 which is to be exchanged is already shifted to the exchange position. Thus, due to this particular characteristic of this printer 2, even if the user must exchange a plurality of non-guaranteed cartridges, he is enabled to perform this cartridge exchange task in a simple and easy manner, so that he may make no mistake. Furthermore since, at the time point that the error is displayed, the cartridge which is to be the object of exchange is already shifted to the exchange position, accordingly it is possible to perform the exchange task with the cartridge just as it is and without canceling the error and shifting it, such as could take place with the prior art.

When thereafter, in response to this error display, the user presses an error cancellation button which is provide on the operation unit 7 (YES in a step S60 of FIG. 3), the CPU 42 updates a number of non-guaranteed product error cancellations (in a step S70 of FIG. 3). In concrete terms, the total number up till now of the number of times cancellation operation has been performed in relation to non-guaranteed product errors is incremented by one. It should be understood that this number of non-guaranteed product error cancellations is stored in a predetermined location within the printer 2. And, by the depression of this error cancellation button, the non-guaranteed product error for this toner cartridge 611 is cancelled, and the display thereof is also eliminated. By doing this, the procedure for this toner cartridge 611, which was a non-guaranteed product, is completed, and the flow of control shifts to a step S100. Accordingly, if this error cancellation button is pressed, the non-guaranteed cartridge is kept installed and is used without performing the exchange of the non-guaranteed cartridge, with respect to the toner cartridge 611 which is the object. Therefore, as described previously, in this case, it is logical to update the number of non-guaranteed product error cancellations.

On the other hand, if the user does not press the error cancellation button on this error display (NO in the step S60 of FIG. 3), then the CPU 42 waits (NO in a step S80 of FIG. 3) for the toner cartridge exchange cover, described above, to be opened and closed. And, when the toner cartridge exchange cover is opened and closed (YES in the step S80 of FIG. 3), it is decided that the task of exchange of the cartridge by the user has been completed, and a decision is made as to whether or not the toner cartridge 611 after exchange is a guaranteed cartridge (in a step S90 of FIG. 3). It should be understood that although, here, it is decided that the exchange task for the cartridge has been completed from the opening and closing of the toner cartridge exchange cover, it would also be acceptable to employ some other method of making that decision. Furthermore, at the time point that it is decided that the exchange task for the cartridge has been completed, the non-guaranteed product error for that toner cartridge 611 is cancelled, and the error display is turned off.

It should be understood that the above described decision as to whether or not a guaranteed cartridge is installed is performed by the same method as the decision in the previously described step S20 as to whether or not the installed cartridge is a non-guaranteed cartridge. If the result of this decision is that it is not a guaranteed cartridge (NO in a step S90 of FIG. 3), then for this toner cartridge 611, the non-guaranteed product error procedure from the previously described step S30 is again performed. In other words since, after the exchange task of the cartridge has been completed, this toner cartridge 611 is returned to its home position, in this case, it is again shifted to the exchange position, and a display of a non-guaranteed product error is provided.

On the other hand, if it is decided that the installed cartridge is a guaranteed cartridge (YES in the step S90 of FIG. 3), then the procedure for the toner cartridge 611 terminates, and the flow of control proceeds to a step S100. In this manner, with this printer 2, if a non-guaranteed cartridge is installed, it is not possible to perform printing until either the cancellation button for a non-guaranteed product error is pressed, or it is exchanged for a guaranteed cartridge. Accordingly, it cannot happen that the user performs printing without knowing that a non-guaranteed cartridge is installed, which would be undesirable. Furthermore since, when the user exchanges the non-guaranteed cartridge for a guaranteed cartridge it is not necessary for him to press the error cancellation button to cancel the error, accordingly the number of non-guaranteed product error cancellations is not updated illogically.

When in this manner the procedure has been completed for the toner cartridge 611 which is the object, a decision is made (in the step S100 of FIG. 3) as to whether or not the above procedures have been completed for all of the toner cartridges 611 for which, in the step S20, it was decided that they were non-guaranteed cartridges; and if there remains at least one which has not yet been processed (NO in the step S100 of FIG. 3), then the next toner cartridge 611 is selected according to the previously described order (in a step S110 of FIG. 3). And the procedures from the step S30 are performed, in the same manner as above, for this next toner cartridge 611 which is selected.

When the procedures described above have been performed for all of the non-guaranteed cartridges, so that the procedures for all of the toner cartridges 611 for which it was decided that they were non-guaranteed cartridges have been completed (YES in the step S100 of FIG. 3), then this sequence of non-guaranteed product error procedures terminates, and the printer 2 transits to its state in which it is capable of performing printing (in a step S120 of FIG. 3).

As has been explained above, with the printer 2 of this embodiment, when the power source is turned on or toner exchange is performed, a check is made as to whether or non a non-guaranteed cartridge is installed, and if such a non-guaranteed cartridge is in fact installed, this non-guaranteed cartridge is automatically shifted to the exchange position, and thereafter a non-guaranteed product error is displayed. Furthermore, if a plurality of such non-guaranteed cartridges are installed, then the series of procedures for cartridge shifting and error display and so on is performed for one cartridge at a time; in other words, if one cartridge for each of the colors Y, M, C, and K is installed, then it is performed for one of these colors at a time, and information is displayed in each error display which indicates which of the cartridges (i.e., which color) is to be the object of being exchanged.

Accordingly, when a non-guaranteed product error is displayed, what the user has to do is just performing the task of exchange for the cartridge which is displayed, it becomes unnecessary for the user to decide upon the cartridge which is to be exchanged and to issue a shift command for that cartridge as in the prior art, so that it becomes possible for him to perform the task of cartridge exchange when a non-guaranteed product error occurs in a simple and easy manner. Furthermore, even if a plurality of non-guaranteed cartridges are installed, it is sufficient for him to repeat the same task being guided by the error display for each cartridge, so that it is possible to prevent undesirable errors such as the installation of a cartridge of the wrong color or the like, and it becomes possible to perform the task of exchange accurately.

Yet further since, at the time point when the non-guaranteed product error is displayed, the cartridge which should be exchanged is already shifted to the exchange position, accordingly, when performing the task of exchange for this cartridge, the user does not need to cancel the error with the error cancellation button and to issue a shift actuation command for the cartridge, so that, even when performing an exchange for a guaranteed cartridge as in the prior art, the illogicality of updating the number of non-guaranteed product error cancellations does not take place.

Moreover, since the procedure is performed independently for each one of the cartridges (i.e. one color), the user can perform the selection, for each one of the cartridges, as to whether he/she uses the non-guaranteed cartridge just as it is, or exchanges it for a guaranteed cartridge. Because of this, even if guaranteed cartridges are not in stock and not available for all of the non-guaranteed cartridges which have been detected, it becomes possible for the user to perform the task of exchange only for some of those cartridges and to get the printer 2 into a state in which it can perform printing, so that it is possible to enhance the environmental applicability for the user.

It should be understood that although, in this embodiment, the printer 2 was a so called four cycle laser printer, the present invention could also be applied to a tandem type printer. In other words, in the case of a device in which, when exchanging a cartridge, it is not necessary to shift the cartridge to any predetermined exchange position, instead of shifting the cartridge to an exchange position as in the embodiment described above, it would be possible to arrange matters so that a preparatory operation is performed of making possible the task of exchange of the object cartridge by the user, and so that, after an error display, the user should immediately proceed to perform the task of exchanging the cartridge.

Furthermore although, in the above-described embodiment, the image forming device was a printer, the present invention may also be applied to an image forming device of a different type, such as a photocopier or a facsimile machine or the like.

The range of protection of the present invention is not to be considered as being limited by the above described embodiment; it covers any invention which comes within the scope of the Patent Claims below, as well as equivalents thereof.

What is claimed is:

1. An image forming device to which a cartridge containing image forming material is removably installed, and which performs image forming using the image forming material contained in said cartridge, comprising:
a detection portion that detects whether or not the cartridge which is installed is a non-guaranteed cartridge which is not the object of a product quality guarantee; and
a shift portion that, when said detection portion detects that the cartridge which is installed is a non-guaranteed cartridge, shifts said non-guaranteed cartridge to a position in which a cartridge can be exchanged.

2. The image forming device according to claim 1, further comprising a display portion that, after said shift portion has shifted the non-guaranteed cartridge to the position in which a cartridge can be exchanged, performs a display which informs a user that an error related to the non-guaranteed cartridge has occurred; and wherein, when exchange of said cartridge which has been shifted to the position in which a cartridge can be exchanged is performed by said user in response to said display, said error is cancelled without any error cancellation operation by said user.

3. The image forming device according to claim 2, wherein, if said detection portion detects that a plurality of cartridges which are installed are non-guaranteed cartridges, display by said display portion and shifting by said shift portion are performed for each one of the plurality of non-guaranteed cartridges in a predetermined order.

4. A control method for an image forming device to which a cartridge containing image forming material is removably installed, and which performs image forming using the image forming material contained in said cartridge, the method comprising:
a detection step of detecting whether or not the cartridge which is installed is a non-guaranteed cartridge which is not the object of a product quality guarantee; and
a shift step of, when it is detected in said detection step that the cartridge which is installed is a non-guaranteed cartridge, shifting said non-guaranteed cartridge to a position in which a cartridge can be exchanged.

5. A computer readable medium recording a control program for an image forming device to which a cartridge containing image forming material is removably installed, and which performs image forming using the image forming material contained in said cartridge, said control program causing said image forming device to execute:
a detection step of detecting whether or not the cartridge which is installed is a non-guaranteed cartridge which is not the object of a product quality guarantee; and
a shift step of, when it is detected in said detection step that the cartridge which is installed is a non-guaranteed cartridge, shifting said non-guaranteed cartridge to a position in which a cartridge can be exchanged.
